(19) United States
(12) Patent Application Publication
(10) Pub. No.: US 2024/0380870 A1
(43) Pub. Date: Nov. 14, 2024

(54) IN-CABIN PROJECTION SYSTEM WITH SAFETY AND CONTROL FEATURES

(71) Applicant: Infineon Technologies AG, Neubiberg (DE)

(72) Inventor: Boris KIRILLOV, Gratwein-Straßengel (AT)

(21) Appl. No.: 18/635,633

(22) Filed: Apr. 15, 2024

(30) Foreign Application Priority Data
Apr. 24, 2023 (DE) 102023203749.1

(51) Int. Cl. H04N 9/31

(52) U.S. Cl. CPC H04N 9/3129; H04N 9/3194

(57) ABSTRACT

An in-cabin projection system includes a projection surface, a light transmitter configured to generate a plurality of pixel light beams corresponding to an image and transmit the plurality of pixel light beams on an optical path toward the projection surface, a two-dimensional scanner arranged on the optical path, wherein the 2D scanner is configured to receive the plurality of pixel light beams from the light transmitter and steer the plurality of pixel light beams along the optical path according to a 2D scanning pattern, a photodetector configured to detect a portion of light from the light transmitter that is reflected back from the projection surface and to generate a photo signal based on the detected light, and a control unit configured to determine based on the photo signal whether an obstacle is located on the optical path.

### CROSS-REFERENCE TO RELATED APPLICATION

This application claims priority to German Patent Application No. 102023203749.1 filed on Apr. 24, 2023, the content of which is incorporated by reference herein in its entirety.

### TECHNICAL FIELD

The present disclosure relates to an in-cabin projection system, a vehicle comprising such an in-cabin projection system, and to a method of projecting an image.

### BACKGROUND

Augmented reality (AR) is a technology that provides an interactive user-experience that combines real-world and computer-generated content. AR delivers visual elements, sound, haptics, and/or other sensory information to a user in order to alter the user's ongoing perception of a real-world environment in real-time. In other words, AR adds digital elements to a live experience of the real-world environment. The sensory information overlaid with the real-world environment can be constructive in order to add the sensory information to the real-world environment or destructive in order to mask part of the real-world environment. The sensory information may be delivered to the user through a device, such as a mobile device. For example, a perceived part of the real-world environment may be augmented with digital information that is superimposed thereon. In some cases, visual content may be superimposed onto the user's line-of-sight (e.g., a user's real-world view). Thus, digital content may be overlaid onto the perceived part of the environment to visually provide additional information to the user. The digital content may be displayed on a transparent substrate or display, such as smart eye-glasses, smart contact lenses, head-up displays (HUDs), and head-mounted displays (HMDs), or projected directly onto a user's retina, as is the case for virtual retinal displays.

Virtual reality (VR) is a technology that creates a totally artificial, computer-generated environment in which a user is immersed. Thus, the users' perception of reality is completely based on virtual information. The user may experience a virtually rendered environment with sight and sound through a VR headset or a multi-projected environment. For example, computer-generated stereo visuals may place the user into the virtually rendered environment that provides the user with an immersive feel that is intended to simulate sensations that the user would otherwise experience in the real-world.

A mixed reality (MR) experience combines elements of both AR and VR such that real-world and digital objects interact in real time. MR may allow real and virtual elements to interact with one another and the user to interact with the virtual elements like they would in the real-world. Here, a real-world environment is blended with a virtual environment. Since MR maintains a connection to the real-world, MR is not considered a fully-immersive experience like VR. The user may experience an MR environment using an MR headset or MR glasses.

These technologies, as well as others that enhance a user's senses, may be referred to as extended reality (XR) technologies.

In-cabin projection systems are becoming increasingly popular particularly in the automotive industry as a means of enhancing the in-car entertainment experience for passengers. Such projection systems allow for the projection of visual content, such as images and video, onto various surfaces within the cabin, such as the dashboard, windshield, ceiling or walls, providing a unique and immersive entertainment experience for passengers. In addition to entertainment purposes, these systems can also be used for informational and educational purposes, such as displaying navigation information or providing educational content to passengers. For example, such in-cabin projection systems can realize the XR technologies. With the increasing demand for more comfortable and entertaining travel options, in-cabin projection systems are poised to become an integral part of the automotive industry. This disclosure aims to provide a solution of in-cabin projection systems featuring a safety mechanism and control features, enabling manufacturers to create cutting-edge products that meet the needs of today's modern travelers. Existing projection systems do not feature any safety and/or control mechanism.

### SUMMARY

Thus, there is a need for an improved in-cabin projection system featuring a safety mechanism and control features.

This need is met by in-cabin projection systems and methods for projecting an image according to the independent claims. Advantageous further developments are provided in the dependent claims.

One or more implementations provide an in-cabin projection system that includes a projection surface, and a light transmitter configured to generate a plurality of pixel light beams corresponding to an image and transmit the plurality of pixel light beams on an optical path toward the projection surface. The in-cabin projection system further includes a two-dimensional (2D) scanner arranged on the optical path, wherein the 2D scanner is configured to receive the plurality of pixel light beams from the light transmitter and steer the plurality of pixel light beams along the optical path according to a 2D scanning pattern. The in-cabin projection system further includes a photodetector configured to detect a portion of light from the light transmitter that is reflected back from the projection surface and to generate a photo signal based on the detected light, and a control unit configured to determine based on the photo signal whether an obstacle is located on the optical path.

One or more implementations provide a vehicle having an in-cabin projection system, wherein the projection surface is a surface of a dashboard of the vehicle.

One or more implementations provide a method of projecting an image. The method includes: generating, by a light transmitter, a plurality of pixel light beams corresponding to an image and transmit the plurality of pixel light beams on an optical path toward a projection surface, receiving, by a two-dimensional (2D) scanner arranged on the optical path, the plurality of pixel light beams and steering the plurality of pixel light beams along the optical path according to a 2D scanning pattern, detecting, by a photodetector, a portion of light from the light transmitter that is reflected back from the projection surface and generating a photo signal based on the detected light, and determining, by a control unit, based on the photo signal whether an obstacle is located on the optical path.

Those skilled in the art will recognize additional features and advantages upon reading the following detailed description, and upon viewing the accompanying drawings.

### BRIEF DESCRIPTION OF THE DRAWINGS

Implementations are described herein making reference to the appended drawings.

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1A is a schematic block diagram of a 2D scanning system according to one or more implementations.

FIG. 1B is a schematic block diagram of a 2D scanning system according to one or more implementations.

FIG. 2 illustrates an example in-cabin projection system according to one or more implementations.

FIG. 3 illustrates an example in-cabin projection system according to one or more implementations.

FIG. 4A illustrates the working principle of an example in-cabin projection system according to one or more implementations.

FIG. 4B illustrates an example time-of-flight (TOF) measurement according to one or more implementations.

FIG. 4C illustrates an example reflectivity map according to one or more implementations.

FIG. 5A illustrates the working principle of an example in-cabin projection system according to one or more implementations.

FIG. 5B illustrates an example TOF measurement according to one or more implementations.

FIG. 6 illustrates the working principle of an example in-cabin projection system according to one or more implementations.

FIG. 7 illustrates an example vehicle according to one or more implementations.

FIG. 8 illustrates an example in-cabin projection system according to one or more implementations.

### DETAILED DESCRIPTION

In the following, details are set forth to provide a more thorough explanation of example implementations. However, it will be apparent to those skilled in the art that these implementations may be practiced without these specific details. In other instances, well-known structures and devices are shown in block diagram form or in a schematic view rather than in detail in order to avoid obscuring the implementations. In addition, features of the different implementations described hereinafter may be combined with each other, unless specifically noted otherwise.

Further, equivalent or like elements or elements with equivalent or like functionality are denoted in the following description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually exchangeable.

In this regard, directional terminology, such as “top,” “bottom,” “below,” “above,” “front,” “behind,” “back,” “leading,” “trailing,” etc., may be used with reference to an orientation of the figures being described. Because parts of the implementations, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

As used herein, the terms “substantially” and “approximately” mean “within reasonable tolerances of manufacturing and measurement.” For example, the terms “substantially” and “approximately” may be used herein to account for small manufacturing tolerances or other factors (e.g., within 5%) that are deemed acceptable in the industry without departing from the aspects of the implementations described herein. For example, a resistor with an approximate resistance value may practically have a resistance within 5% of the approximate resistance value. As another example, an approximate signal value may practically have a signal value within 5% of the approximate signal value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

In-cabin projection systems project visual content on any surface of a vehicle, e.g., a surface of the dashboard or a control surface comprising a number of buttons, for instance. The use of projection systems can pose risks to the user's eyes, such as retinal damage from exposure to high-intensity light, particularly if the projection system has a light beam scanning (LBS)-based architecture that relies on the emission of high-intensity laser beams. Operating the light emitters in an eye-safe mode at all times may lead to poor image brightness and quality and is therefore disadvantageous. Therefore, a projection system is proposed that incorporates an eye safety feature, ensuring that the user is protected from harmful light emissions while still benefiting from the advantages of LBS-based projection technology. This innovative system is configured to enhance user safety and improve overall user experience by providing a clear, informative, and safe display without risking damage to the user's eye if looking into the light beam.

Some implementations disclosed herein are directed to a projection system that has a light beam scanning (LBS)-based architecture with a light transmitter, a projection surface, e.g., a surface of a dashboard or an intermediate diffuser or diffuser screen, and a photodetector that is configured to detect a portion of light from the light transmitter that is reflected from the projection surface to the photodetector, wherein the photodetector and the light transmitter are arranged on a same side with respect to the projection surface. Based on the detected reflected light, the system can determine an obstacle is located on the optical path between the light transmitter and the projection surface.

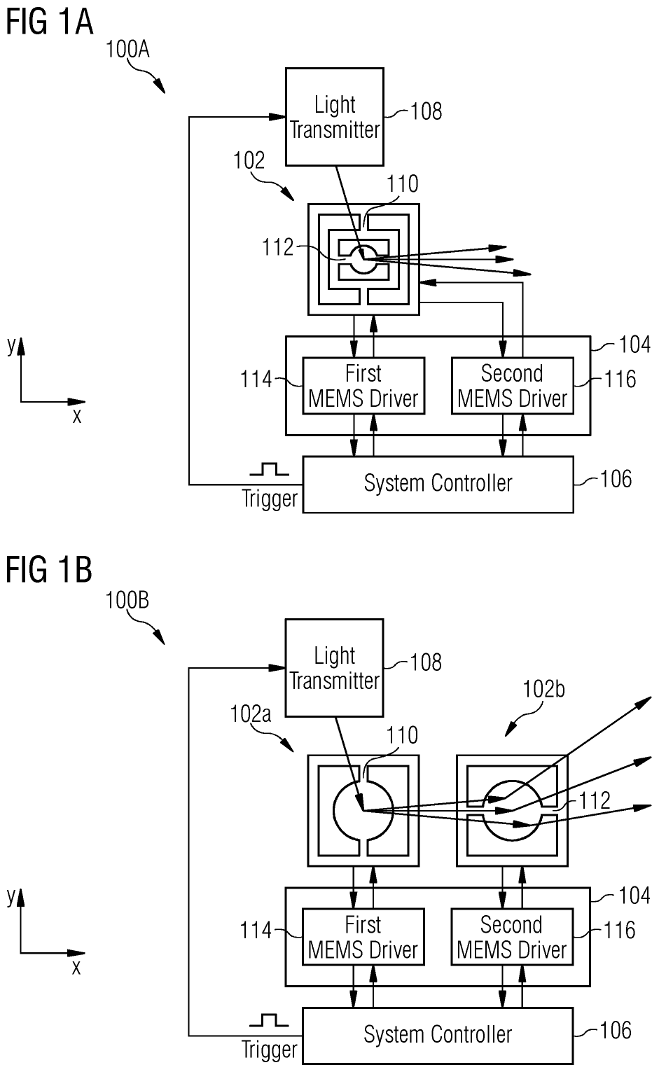

FIG. 1A is a schematic block diagram of a 2D scanning system 100A according to one or more implementations. In particular, the 2D scanning system 100A includes a microelectromechanical system (MEMS) mirror 102 implemented as a single scanning structure that is configured to steer or otherwise deflect light beams according to a 2D scanning pattern. The 2D scanning pattern has a pattern variation in a first dimension and a pattern variation in a second dimension. The 2D scanning system 100A further includes a MEMS driver system 104, a system controller 106, and a light transmitter 108.

In the example shown in FIG. 1A, the MEMS mirror 102 is a mechanical moving mirror (e.g., a MEMS micro-mirror) integrated on a semiconductor chip (not shown). The MEMS mirror 102 is configured to rotate or oscillate via rotation about two scanning axes that are typically orthogonal to each other. For example, the two scanning axes may include a first scanning axis 110 that enables the MEMS mirror 102 to steer light in a first scanning direction (e.g., an x-direction) and a second scanning axis 112 that enables the MEMS mirror 102 to steer light in a second scanning direction (e.g., a y-direction). As a result, the MEMS mirror 102 can direct light beams in two dimensions according to the 2D scanning pattern and may be referred to as a 2D MEMS mirror.

A scan can be performed to illuminate an area referred to as a field of view. The scan, such as an oscillating horizontal scan (e.g., from left to right and right to left of a projection surface), an oscillating vertical scan (e.g., from bottom to top and top to bottom of a projection surface), or a combination thereof (e.g., a Lissajous scan or a raster scan) can illuminate the projection surface in a continuous scan fashion. In some implementations, the 2D scanning system 100A may be configured to transmit successive light beams, for example, as successive light pulses, in different scanning directions to scan the projection surface. In other words, the projection surface can be illuminated by a scanning operation. In general, an entire projection surface represents a scanning area defined by a full range of motion of the MEMS mirror 102 at which the MEMS mirror 102 is driven. Thus, the entire projection surface is delineated by a left edge, a right edge, a bottom edge, and a top edge. The entire projection surface can also be referred to as a field of illumination or as a projection area in a projection plane onto which an image is projected.

The MEMS mirror 102 can direct a transmitted light beam at a desired 2D coordinate (e.g., an x-y coordinate) on the projection surface. In image projection systems, the desired 2D coordinate may correspond to an image pixel of a projected image, with different 2D coordinates corresponding to different image pixels of the projected image. Accordingly, multiple light beams transmitted at different transmission times can be steered by the MEMS mirror 102 at the different 2D coordinates of the projection surface in accordance with the 2D scanning pattern. The MEMS mirror 102 can be used to scan the field of view in both scanning directions by changing an angle of deflection of the MEMS mirror 102 on each of the first scanning axis 110 and the second scanning axis 112.

A rotation of the MEMS mirror 102 on the first scanning axis 110 may be performed between two predetermined extremum deflection angles (e.g., +/−5 degrees, +/−15 degrees, etc.). Likewise, a rotation of the MEMS mirror 102 on the second scanning axis 112 may be performed between two predetermined extremum deflection angles (e.g., +/−5 degrees, +/−15 degrees, etc.). In some implementations, depending on the 2D scanning pattern, the two predetermined extremum deflection angles used for the first scanning axis 110 may be the same as the two predetermined extremum deflection angles used for the second scanning axis 112. In some implementations, depending on the 2D scanning pattern, the two predetermined extremum deflection angles used for the first scanning axis 110 may be different from the two predetermined extremum deflection angles used for the second scanning axis 112.

In some implementations, the MEMS mirror 102 can be a resonator (e.g., a resonant MEMS mirror) configured to oscillate side-to-side about the first scanning axis 110 at a first frequency (e.g., a first resonance frequency) and configured to oscillate side-to-side about the second scanning axis 112 at a second frequency (e.g., a second resonance frequency). Thus, the MEMS mirror 102 can be continuously driven about the first scanning axis 110 and the second scanning axis 112 to perform a continuous scanning operation. As a result, light beams reflected by the MEMS mirror 102 are scanned onto the projection surface in accordance with the 2D scanning pattern.

Different frequencies or a same frequency may be used for the first scanning axis 110 and the second scanning axis 112 for defining the 2D scanning pattern. For example, a raster scanning pattern or a Lissajous scanning pattern may be achieved by using different frequencies for the first frequency and the second frequency. Raster scanning and Lissajous scanning are two types of scanning techniques that can be implemented in display applications, light scanning applications, and light steering applications, to name a few. As an example, Lissajous scanning is typically performed using two resonant scanning axes which are driven at different constant scanning frequencies with a defined fixed frequency ratio therebetween that forms a specific Lissajous pattern and frame rate. In order to properly carry out the Lissajous scanning and the raster scanning, synchronization of the two scanning axes is performed by the system controller 106 in conjunction with transmission timings of the light transmitter 108.

For each respective scanning axis, including the first scanning axis 110 and the second scanning axis 112, the MEMS mirror 102 includes an actuator structure used to drive the MEMS mirror 102 about the respective scanning axis. Each actuator structure may include interdigitated finger electrodes made of interdigitated mirror combs and frame combs to which a drive voltage (e.g., an actuation signal or driving signal) is applied by the MEMS driver system 104. Applying a difference in electrical potential between interleaved mirror combs and frame combs creates a driving force between the mirror combs and the frame combs, which creates a torque on a mirror body of the MEMS mirror 102 about the intended scanning axis. The drive voltage can be toggled between two voltages, resulting in an oscillating driving force. The oscillating driving force causes the MEMS mirror 102 to oscillate back and forth on the respective scanning axis between two extrema. Depending on the configuration, this actuation can be regulated or adjusted by adjusting the drive voltage off time, a voltage level of the drive voltage, or a duty cycle.

In other examples, the MEMS mirror 102 may use other actuation methods to drive the MEMS mirror 102 about the respective scanning axes. For example, these other actuation methods may include electromagnetic actuation and/or piezoelectric actuators. In electromagnetic actuation, the MEMS mirror 102 may be immersed in a magnetic field, and an alternating electric current through conductive paths may create the oscillating torque around the scanning axis. Piezoelectric actuators may be integrated in leaf springs of the MEMS mirror 102, or the leaf springs may be made of piezoelectric material to produce alternating beam bending forces in response to an electrical signal to generate the oscillation torque.

The MEMS driver system 104 is configured to generate driving signals (e.g., actuation signals) to drive the MEMS mirror 102 about the first scanning axis 110 and the second scanning axis 112. In particular, the MEMS driver system 104 is configured to apply the driving signals to the actuator structure of the MEMS mirror 102. In some implementations, the MEMS driver system 104 includes a first MEMS driver 114 configured to drive the MEMS mirror 102 about the first scanning axis 110 and a second MEMS driver 116 configured to drive the MEMS mirror 102 about the second scanning axis 112. In implementations in which the MEMS mirror 102 is used as an oscillator, the first MEMS driver 114 configured to drive an oscillation of the MEMS mirror 102 about the first scanning axis 110 at the first frequency, and the second MEMS driver 116 is configured to drive an oscillation of the MEMS mirror 102 about the second scanning axis 112 at the second frequency.

The first MEMS driver 114 may be configured to sense a first rotational position of the MEMS mirror 102 about the first scanning axis 110 and provide first position information indicative of the first rotational position (e.g., tilt angle or degree of rotation about the first scanning axis 110) to the system controller 106. Similarly, the second MEMS driver 116 may be configured to sense a second rotational position of the MEMS mirror 102 about the second scanning axis 112 and provide second position information indicative of the second rotational position (e.g., tilt angle or degree of rotation about the second scanning axis 112) to the system controller 106.

The system controller 106 may use the first position information and the second position information to trigger light beams at the light transmitter 108. For example, the system controller 106 may use the first position information and the second position information to set a transmission time of light transmitter 108 in order to target a particular 2D coordinate of the 2D scanning pattern. Thus, a higher accuracy in position sensing of the MEMS mirror 102 by the first MEMS driver 114 and the second MEMS driver 116 may result in the system controller 106 providing more accurate and precise control of other components of the 2D scanning system 100A.

As noted above, the first MEMS driver 114 and the second MEMS driver 116 may apply a drive voltage to a corresponding actuator structure of the MEMS mirror 102 as the driving signal to drive a rotation (e.g., an oscillation) of the MEMS mirror 102 about a respective scanning axis (e.g., the first scanning axis 110 or the second scanning axis 112). The drive voltage can be switched or toggled between a high-voltage (HV) level and a low-voltage (LV) level resulting in an oscillating driving force. In some implementations, the LV level may be zero (e.g., the drive voltage is off), but is not limited thereto and could be a non-zero value. When the drive voltage is toggled between an HV level and an LV level and the LV level is set to zero, it can be said that the drive voltage is toggled on and off (HV on/off). The oscillating driving force causes the MEMS mirror 102 to oscillate back and forth on the first scanning axis 110 or the second scanning axis 112 between two extrema. The drive voltage may be a constant drive voltage, meaning that the drive voltage is the same voltage when actuated (e.g., toggled on) or one or both of the HV level or the LV level of the drive voltage may be adjustable. However, it will be understood that the drive voltage is being toggled between the HV level and the LV level in order to produce the mirror oscillation. Depending on a configuration, this actuation can be regulated or adjusted by the system controller 106 by adjusting the drive voltage off time, a voltage level of the drive voltage, or a duty cycle. As noted above, frequency and phase of the drive voltage can also be regulated and adjusted.

In some implementations, the system controller 106 is configured to set a driving frequency of the MEMS mirror 102 for each scanning axis and is capable of synchronizing the oscillations about the first scanning axis 110 and the second scanning axis 112. In particular, the system controller 106 may be configured to control an actuation of the MEMS mirror 102 about each scanning axis by controlling the driving signals. The system controller 106 may control the frequency, the phase, the duty cycle, the HV level, and/or the LV level of the driving signals to control the actuations about the first scanning axis 110 and the second scanning axis 112. The actuation of the MEMS mirror 102 about a particular scanning axis controls its range of motion and scanning rate about that particular scanning axis.

For example, to make a Lissajous scanning pattern reproduce itself periodically with a frame rate frequency, the first frequency at which the MEMS mirror 102 is driven about the first scanning axis 110 and the second frequency at which the MEMS mirror 102 is driven about the second scanning axis 112 are different. A difference between the first frequency and the second frequency is set by a fixed frequency ratio that is used by the 2D scanning system 100A to form a repeatable Lissajous pattern (frame) with a frame rate. A new frame begins each time the Lissajous scanning pattern restarts, which may occur when a phase difference between a mirror phase about the first scanning axis 110 and a mirror phase about the second scanning axis 112 is zero. The system controller 106 may set the fixed frequency ratio and synchronize the oscillations about the first scanning axis 110 and the second scanning axis 112 to ensure this fixed frequency ratio is maintained based on the first position information and the second position information received from the first MEMS driver 114 and the second MEMS driver 116, respectively.

The light transmitter 108 may be a red-green-blue (RGB) light transmitter having red (R), green (G), and blue (B) light sources configured to generate RGB light beams. For example, the light transmitter 108 may include a red laser diode or light emitting diode for generating a red light beam, a green laser diode or light emitting diode for generating a green light beam, a blue laser diode or light emitting diode for generating a blue light beam, and first optical elements that combine the three colored light beams into an RGB light beam for output from the light transmitter 108. Accordingly, the light transmitter 108 is configured to transmit each RGB light beam on a transmission path toward the MEMS mirror 102. Each RGB light beam may be generated as a light pulse, and the light transmitter 108 may sequentially transmit multiple RGB light beams as the MEMS mirror 102 changes its transmission direction in order to target different 2D coordinates. A transmission sequence of the multiple RGB light beams and a timing thereof may be implemented by the light transmitter 108 according to a trigger signal received from the system controller 106.

It is to be noted that a particular RGB light beam may be made of a single color of light, a combination of two colors of light, or a combination of all three colors or light. For example, the system controller 106 may control which R, G, B light sources of the light transmitter 108 is triggered for a light transmission, including some or all of the R, G, B light sources. While some of the R, G, B light sources may remain inactive during a light transmission, an output light beam may still be referred to as an RGB light beam (e.g., despite not including all three colors of light). Alternatively, an “RGB light beam” may be referred to as a “pixel light beam” that includes one or more colors of light depending on the desired pixel color to be projected into the field of view. For example, a particular RGB light beam may correspond to a pixel of an image projected into the field of view or an image projected onto a display and different RGB light beams may be transmitted for different pixels of the image or for different image frames. Thus, the terms “RGB light beam” and “pixel light beam” can be used interchangeably.

The system controller 106 is configured to control components of the 2D scanning system 100A. In certain applications, the system controller 106 may also be configured to receive programming information with respect to the 2D scanning pattern and control a timing of the plurality of light beams generated by the light transmitter 108 based on the programming information. Thus, the system controller 106 may include both processing and control circuity that is configured to generate control signals for controlling the light transmitter 108, the first MEMS driver 114, and the second MEMS driver 116.

The system controller 106 is configured to set the driving frequencies of the MEMS mirror 102 for the first scanning axis 110 and the second scanning axis 112 and is capable of synchronizing the oscillations about the first scanning axis 110 and the second scanning axis 112 to generate the 2D scanning pattern. In some implementations, in which the plurality of light beams is used, the system controller 106 may be configured to generate the trigger signal used for triggering the light transmitter 108 to generate the plurality of light beams. Using the trigger signal, the system controller 106 can control the transmission times of the plurality of light beams (e.g., RGB light beams or pixel light beams) of the light transmitter 108 to achieve a desired illumination pattern within the field of view. The desired illumination pattern is produced by a combination of the 2D scanning pattern produced by the MEMS mirror 102 and the transmission times triggered by the system controller 106. In some implementations in which the continuous light beam is used, the system controller 106 may be configured to control a frequency modulation of the continuous light beam via a control signal provided to the light transmitter 108.

As indicated above, FIG. 1A is provided merely as an example. Other examples may differ from what is described with regard to FIG. 1A. In practice, the 2D scanning system 100A may include additional components, fewer components, different components, or differently arranged components than those shown in FIG. 1A without deviating from the disclosure provided above. In addition, in some implementations, the 2D scanning system 100A may include one or more additional 2D MEMS mirrors or one or more additional light transmitters used to scan one or more additional projection surfaces. Additionally, two or more components shown in FIG. 1A may be implemented within a single component, or a single component shown in FIG. 1A may be implemented as multiple, distributed components. Additionally, or alternatively, a set of components (e.g., one or more components) of the 2D scanning system 100A may perform one or more functions described as being performed by another set of components of the 2D scanning system 100A.

FIG. 1B is a schematic block diagram of a 2D scanning system 100B according to one or more implementations. In particular, the 2D scanning system 100B includes two MEMS mirrors, a first MEMS mirror 102a and a second MEMS mirror 102b, that are optically coupled in series to steer or otherwise deflect light beams according to a 2D scanning pattern. The first MEMS mirror 102a and the second MEMS mirror 102b are similar to the MEMS mirror 102 described in FIG. 1A, with the exception that the first MEMS mirror 102a and the second MEMS mirror 102b are configured to rotate about a single scanning axis instead of two scanning axes. The first MEMS mirror 102a is configured to rotate about the first scanning axis 110 to steer light in the x-direction and the second MEMS mirror 102b is configured to rotate about the second scanning axis 112 to steer light in the y-direction. Similar to the MEMS mirror 102 described in FIG. 1A, the first MEMS mirror 102a and the second MEMS mirror 102b may be resonant MEMS mirrors configured to oscillate about the first scanning axis 110 and the second scanning axis 112, respectively.

Because each of the first MEMS mirror 102a and the second MEMS mirror 102b is configured to rotate about a single scanning axis, each of the first MEMS mirror 102a and the second MEMS mirror 102b is responsible for scanning light in one dimension. As a result, the first MEMS mirror 102a and the second MEMS mirror 102b may be referred to as one-dimensional (1D) MEMS mirrors. In the example shown in FIG. 1B, the first MEMS mirror 102a and the second MEMS mirror 102b are used together to steer light beams in two dimensions. The first MEMS mirror 102a and the second MEMS mirror 102b are arranged sequentially along a transmission path of the light beams such that one of the MEMS mirrors (e.g., the first MEMS mirror 102a) first receives a light beam and steers the light beam in a first dimension and the second one of the MEMS mirrors (e.g., the second MEMS mirror 102b) receives the light beam from the first MEMS mirror 102a and steers the light beam in a second dimension. As a result, the first MEMS mirror 102a and the second MEMS mirror 102b operate together to steer the light beam generated by the light transmitter 108 in two dimensions. In this way, the first MEMS mirror 102a and the second MEMS mirror 102b can direct the light beam at a desired 2D coordinate (e.g., an x-y coordinate) onto the projection surface. Multiple light beams can be steered by the first MEMS mirror 102a and the second MEMS mirror 102b at different 2D coordinates of a 2D scanning pattern.

The MEMS driver system 104, the system controller 106, and the light transmitter 108 are configured to operate as similarly described above in reference to FIG. 1A. The first MEMS driver 114 is electrically coupled to the first MEMS mirror 102a to drive the first MEMS mirror 102a about the first scanning axis 110 and to send a position of the first MEMS mirror 102a about the first scanning axis 110 to provide first position information to the system controller 106. Similarly, the second MEMS driver 116 is electrically coupled to the second MEMS mirror 102b to drive the second MEMS mirror 102b about the second scanning axis 112 and to send a position of the second MEMS mirror 102b about the second scanning axis 112 to provide second position information to the system controller 106.

As indicated above, FIG. 1B is provided merely as an example. Other examples may differ from what is described with regard to FIG. 1B. In practice, the 2D scanning system 100B may include additional components, fewer components, different components, or differently arranged components than those shown in FIG. 1B without deviating from the disclosure provided above. In addition, in some implementations, the 2D scanning system 100B may include one or more additional 1D MEMS mirrors or one or more additional light transmitters used to scan one or more additional projection surfaces. Additionally, two or more components shown in FIG. 1B may be implemented within a single component, or a single component shown in FIG. 1B may be implemented as multiple, distributed components. Additionally, or alternatively, a set of components (e.g., one or more components) of the 2D scanning system 100B may perform one or more functions described as being performed by another set of components of the 2D scanning system 100B.

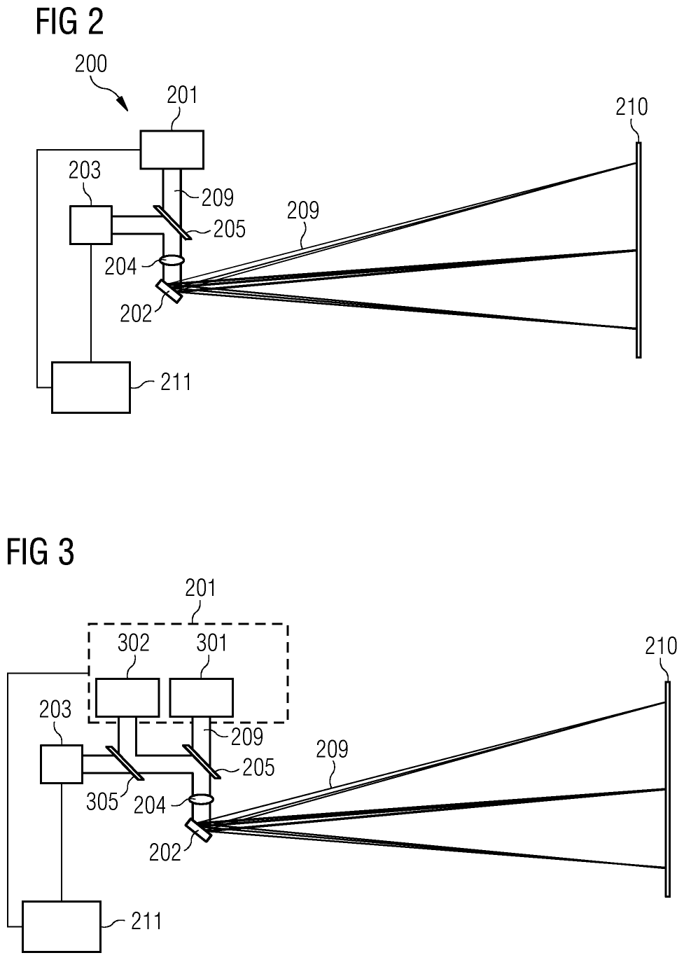

FIG. 2 illustrates an example in-cabin projection system 200 according to one or more implementations. The projection system 200 can include a projection surface 210 (e.g., a surface of a vehicle's dashboard or control panel) and a light transmitter 201 that can be configured to generate a plurality of pixel light beams corresponding to an image and transmit the plurality of pixel light beams on an optical path 209 toward the projection surface 210. The projection system 200 may further include a pre-scan lens 204 (e.g., a focusing lens) and a 2D scanner 202 that are arranged sequentially along the optical path 209 between the light transmitter 201 and the projection surface 210. The in-cabin projection system 200 may be configured to project the image onto a projection surface 210 of a vehicle, e.g., a surface of the dashboard or a control surface. The projection surface therefore is a surface, on which the image projected by the projection system 200 can be perceived by a user. The projection system 200 can further include a photodetector 203 for detecting light that is reflected back from the projection surface 210 or an obstacle. The projection system 200 can further include a control unit 211 for controlling an emission of the light transmitter 201 and for receiving and processing a photo signal from the photodetector 203. The control unit 211 may be a controller, such as system controller 106, and/or other control circuitry.

The light transmitter 201 may be similar to the light transmitter 108 described in connection with FIGS. 1A and 1B. In some implementations, the light transmitter 201 may be part of an image generation unit that includes the 2D scanner 202. For example, the light transmitter 201 and the 2D scanner 202 may be used together to generate the image. The light transmitter 201 may be configured to sequentially generate a plurality of pixel light beams corresponding to an image and, thereby, sequentially transmit the plurality of pixel light beams on the optical path 209 toward the 2D scanner 202.

The 2D scanner 202 may be a MEMS mirror that is included in a 2D scanning system similar to the 2D scanning system 100A described in connection with FIG. 1A or similar to the 2D scanning system 100B described in connection with FIG. 1B. Thus, the 2D scanner 202 may be configured to receive the plurality of pixel light beams from the light transmitter 201 and steer the plurality of pixel light beams along the optical path 209 according to a 2D scanning pattern. For example, as the 2D scanner 202 changes its angle of deflection during a scanning operation, the 2D scanner 202 may scan the plurality of pixel light beams onto the projection surface 210 according to the 2D scanning pattern.

The pre-scan lens 204 may be used to focus the plurality of pixel light beams onto the projection surface 210 such that the image is projected in focus onto the projection surface 210. For example, the pre-scan lens 204 may be arranged on the optical path 209 between the light transmitter 201 and the 2D scanner 202, and the pre-scan lens 204 may be configured to receive the plurality of pixel light beams from the light transmitter 201 and focus the plurality of pixel light beams onto the projection surface 210. The pre-scan lens 204 may have a focal length f that is equal to a sum of a first distance between the pre-scan lens 204 and the 2D scanner 202, along the optical path, and a second distance between the 2D scanner 202 and the projection surface 210, along the optical path.

The projection surface 210 may be arranged and an end of the optical path 209. The projection surface 210 may be configured to receive the plurality of pixel light beams from the 2D scanner 202. The projection surface 210 can be a part of a vehicle's dashboard or a control surface of a vehicle. Alternatively, the projection surface 210 may be configured to expand a beam width of each pixel light beam of the plurality of pixel light beams to generate a plurality of divergent pixel light beams. In other words, the projection surface 210 in such implementations acts as a diffuser optical component that may be configured to produce divergent light beams to increase an optical spread of each of the plurality of pixel light beams, e.g., for realizing an eyebox of a HUD display using a HUD reflector. As a result, in such implementations a beam width of the plurality of pixel light beams is increased by the projection surface 210 in order to increase a size of an eyebox (e.g., a size of an area at which the projected image can be perceived by the user).

The photodetector 203 may be an optical photodiode that is sensitive at an emission wavelength of the light transmitter 201. The photodetector 203 may be arranged to receive at least a portion of the plurality of pixel light beams from the light transmitter 201 that is reflected back from the projection surface 210. In other words, the photodetector 203 may be configured to detect a portion of light from the light transmitter 201 that is received from the projection surface 210 via back-reflection or backscattering. To this end, the projection system 200 may further comprise an optical beam splitter 205 on the optical path 209 between the light transmitter 201 and the 2D scanner 202, wherein the beam splitter 205 is configured to transmit substantially all light from the light transmitter 201 to the 2D scanner 202 and deflect at least some light received from the from the 2D scanner 202 toward the photodetector 203. Further optical components such as optical waveplates can be arranged on the optical path 209 for adjusting a polarization direction of the light to a principal axis of the beam splitter 205, which can be a polarizing beam splitter, for example. Alternatively, the deflection of back reflected light can be realized using an optical circulator. In this implementation, the photodetector 203 is sensitive to an emission wavelength of the light transmitter 201 in the visible domain, e.g., to red, green and/or blue light. The photodetector 203 is configured to generate an electrical photo signal based on the detected light.

The control unit 211 may be coupled to the photodetector 203 for receiving the photo signal. The control unit 211 may be configured to determine from the photo signal whether an obstacle is located on the optical path 209 between the 2D scanner 202 and the projection surface 210, e.g., a body part of a user. The control unit 211 may be also coupled to the light transmitter 201 for controlling an emission of light of the light transmitter 201. The control unit 211 may be configured to provide a control signal to the light transmitter for activating or disabling an emission of light by the light transmitter 201. The control signal may be generated based on the photo signal or information derived from the photo signal. In other words, the control unit 211 can be configured to disable the emission of light of the light transmitter 201 if the photo signal indicates an obstacle located on the optical path 209 between the 2D scanner 202 and the projection surface 210.

FIG. 3 illustrates a further example in-cabin projection system 200 according to one or more implementations. Compared to the example of FIG. 2, in such implementations the light transmitter 201 may comprise a first emitter 301 and a second emitter 302. The first emitter 301 may be configured to emit the plurality of pixel light beams in the visible portion of the electromagnetic spectrum onto the light path 209, which are scanned onto the projection surface 210 by the 2D scanner 202 as detailed with respect to the example of FIG. 2. The second emitter 302 may be configured to emit a monitoring pixel light beam onto the optical path 209 that may be outside the visible domain. For example, the monitoring pixel light beam is characterized by an optical wavelength in the infrared domain, in particular, in the near-infrared (NIR) domain of the electromagnetic spectrum. The beam splitter 205 to this end can be a dichroic beam splitter, for example, that is configured to transmit light in the visible domain and deflect light in the infrared domain, for instance. The photodetector 203 in this example is sensitive at an emission wavelength of the second emitter 302 and arranged on a same side of the beam splitter 205 as the second emitter 302. Thus, the photodetector 203 is arranged to detect a portion of the monitoring light beam that is reflected back from the projection surface 210.

A further beam splitter or circulator 305 can be arranged to direct light from the second emitter 302 toward the beam splitter 205 onto the optical path 209, and to direct light received from the beam splitter 205 to the photodetector 203. Further optical components such as optical waveplates can be arranged on the optical path between the further beam splitter 305, the second emitter 302 and the photodetector 203 for adjusting a polarization direction of the light to a principal axis of the further beam splitter 305, which can be a polarizing beam splitter, for example.

The control unit 211 in this example can be configured to enable and disable an emission of the first emitter 301 of the light transmitter 201 based on the photo signal generated by the photodetector 203 based on the detected back-reflected monitoring light beam. For example, an emission of the first emitter 301 is disabled when the photo signal or information derived from the photo signal indicates an obstacle located on the optical path 209 between the 2D scanner 202 and the projection surface 210.

As indicated above, FIGS. 2 and 3 are provided merely as examples. Other examples may differ from what is described with regard to FIGS. 2 and 3. The number and arrangement of components shown in FIGS. 2 and 3 are provided as an example. In practice, the projection system 200 may include additional components, fewer components, different components, or differently arranged components than those shown in FIGS. 2 and 3. Two or more components shown in FIGS. 2 and 3 may be implemented within a single component, or a single component shown in FIGS. 2 and 3 may be implemented as multiple, distributed components. Additionally, or alternatively, a set of components (e.g., one or more components) of the in-cabin projection system 200 may perform one or more functions described as being performed by another set of components of the projection system 200.

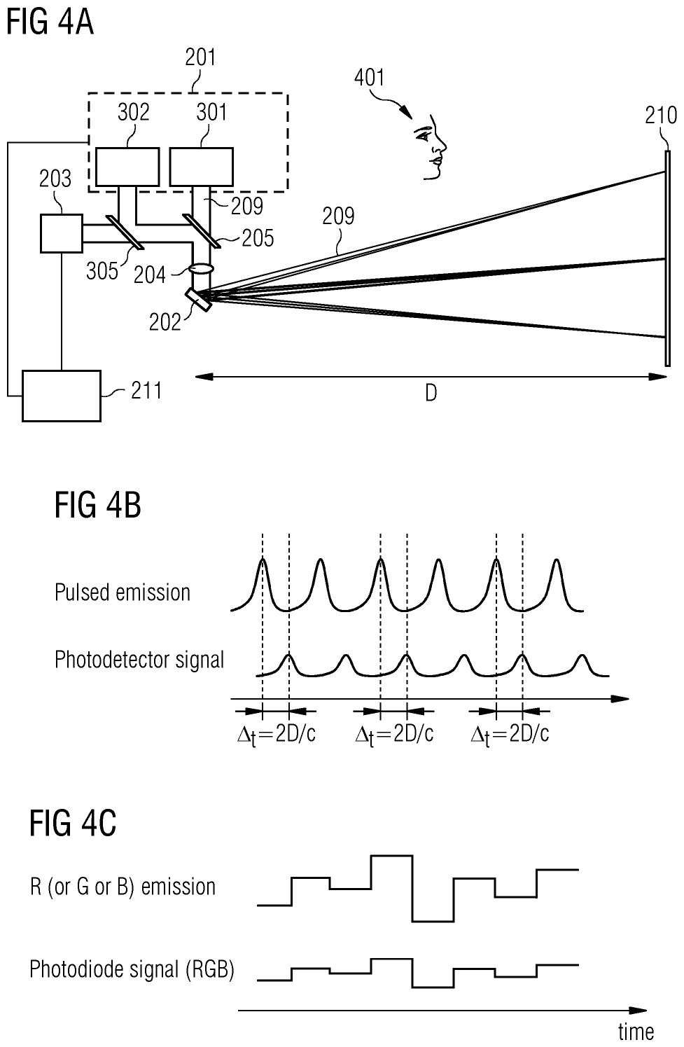

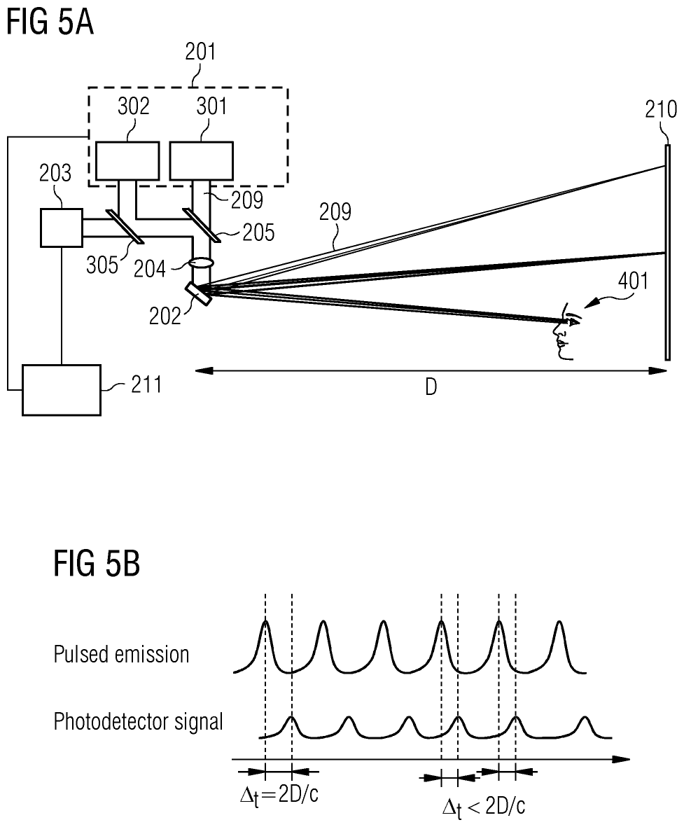

FIGS. 4A to 4C and 5A to 5B illustrate the working principle of detecting whether an obstacle 401, e.g., a user's body part, is located on the optical path 209 between the 2D scanner 202 and the projection surface 210. The figures illustrate the working principle based on the example implementation of the in-cabin projection system 200 of FIG. 3. However, the working principle likewise applies to other implementations of the projection system 200 in an analogous manner, for example to the implementation of FIG. 2.

FIG. 4A shows the operating projection system 200 with a user 401 that is not blocking the optical path 209 with any body part. In other words, the optical path 209 between the 2D scanner 202 and the projection surface 210 is unobstructed. FIG. 5A, on the other hand, shows the operating projection system 200 with a user 401 blocking the optical path 209 between the 2D scanner 202 and the projection surface 210 at least for some scanning directions, e.g., with his head. The control unit 211 can determine whether the optical path 209 between the 2D scanner 202 and the projection surface 210 is unobstructed based on a time-of-flight (TOF) measurement, for instance. To this end, the control unit 211 can be configured to control the light transmitter 201, e.g., the second emitter 302, to emit the monitoring light beams as light pulses that are scanned toward the projection surface 210 alongside the visible pixel light beams from the first emitter 301. The control unit 211 may further be configured to determine a time difference of a photo signal generated by the photodetector 203 in response to a corresponding light pulse from the second emitter 302 and compare this time difference to a reference time difference, e.g., the expected time difference of an unobstructed optical path 209.

This TOF measurement is illustrated in FIGS. 4B and 5B for the above-described cases of an obstructed and obstructed optical path 209 of FIGS. 4A and 4B, respectively. With reference to FIG. 4A, the time shift Δt between the emission of a light pulse and the detection of the back reflection from the projection surface 210 by the photodetector 203 is given by Δt=d/c, with d denoting the distance that the light travels and c denoting the speed of light. As typically the distance D between the 2D scanner 202 and the projection surface 210 is orders of magnitude larger than the optical path 209 between the light transmitter 201, photodetector 203 and the 2D scanner, the total distance travelled can be approximated as d=2*D accounting for the dual passage due to the roundtrip.

As shown in FIG. 4B for an unobstructed optical path 209 between the 2D scanner 202 and the projection surface 210, the detected time difference between the emitted pulses and the corresponding photo signals remains constant and fulfills the above-described relation, neglecting the minor path length difference due to the scanning angles. As shown in FIG. 5B, on the other hand, if an obstacle 401 is located on the optical path 209 between the 2D scanner 202 and the projection surface 210, at least some of the detected photo signals will occur at a time difference that is smaller than the expected time difference of an unobstructed optical path 209. Thus, the control unit 211 in this case can determine that an obstacle is located on the optical path 209 and disable the emission of the pixel light beams of the first emitter 301 of the light transmitter 201, for instance, for eye-safety reasons. The emission of the monitoring light beam can be left activated for monitoring when the obstacle is removed from the optical path 209. It is obvious to a skilled person that the monitoring light beam from the second emitter 302 is emitted at optical wavelengths and optical intensities that are considered eye safe.

FIG. 4C illustrates the monitoring of the intensity of the detected back reflected light over time as an alternative or in addition to monitoring the TOF as discussed above. Depending on surface properties of the projection surface 210, a variation of the back-reflected light intensity is expected for different scanning angles and/or different optical wavelengths (red, green, blue, for instance). Therein, the detected photo signal is determined by the emission of the light transmitter 201 and the reflectivity of the projection surface 210. However, the intensity of the back reflected light is expected to remain substantially constant over time at each fixed scanning angle of the 2D scanner. In other words, the same reflectivity map, or photo signal profile, is expected for any given scanning pattern. Thus, if an obstacle 401 is located on the optical path 209, a deviation from a pre-calibrated reference reflectivity map is expected that can be determined by the control unit 211 via monitoring the photo signal from the photodetector 203 over time and comparing this to the reference reflectivity map.

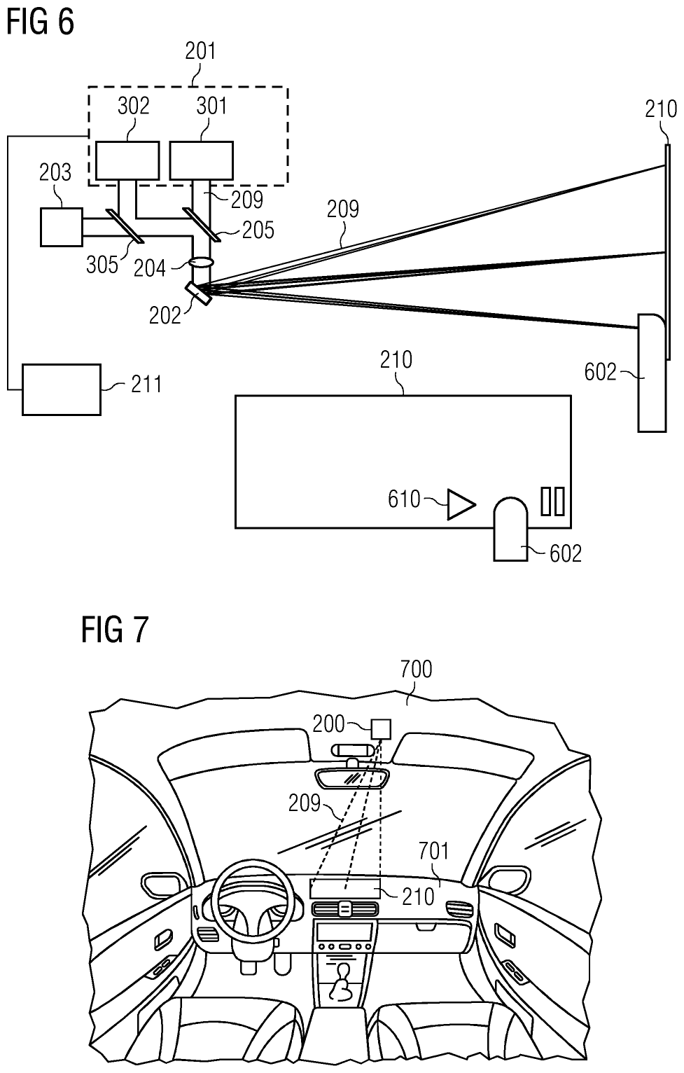

FIG. 6 shows the example in-cabin projection system 200 of FIG. 3, wherein the control unit 211 is configured to determine whether the obstacle 401 on the optical path 209 is a finger 602 placed in front or in contact with the projection surface 210. Based on the TOF measurement and/or on the reflectivity map detection, the control unit 211 can determine based on the photo signal from the photodetector 203 whether the obstacle on the optical path 209 is a finger 602 of a user. Moreover, upon detection of a finger 602, the control unit 211 can be further configured to control the emission of the pixel light beams to project control elements 610 onto the projection surface 210 in the vicinity of the detected finger 602, for instance control elements of a media player or navigation system. The control unit 211 can further be configured to determine whether the finger 602 is moved or located towards one of the projected control elements 610 and generate an output signal to be provided to an external processing unit for initiating an action assigned to the control element 610, e.g., to play or pause playback of a media item or to adjust settings of a navigation system that is projected onto the projection surface 210.

FIG. 7 shows a vehicle 700, for example a car, comprising an in-cabin projection system 200, wherein the projection surface 210 is a surface of a dashboard 701 of the vehicle 700.

FIG. 7 shows an example vehicle 700 according to one or more implementations. The vehicle 700 includes an in-cabin volume that is defined by a vehicle chassis and a windshield. The in-cabin volume may be referred to as a passenger compartment of the vehicle 700 in which one or more passengers are located during use of the vehicle. The vehicle 700 may also include a dashboard 701 that includes a dashboard surface. The vehicle 700 comprises an in-cabin projection system 200, wherein the projection surface 210 is a surface of the dashboard 701 of the vehicle 700, for example. As indicated above, FIG. 7 is provided as an example. Other examples may differ from what is described with regard to FIG. 7. For example, the vehicle 700 may be any type of vehicle that includes a dashboard 701.

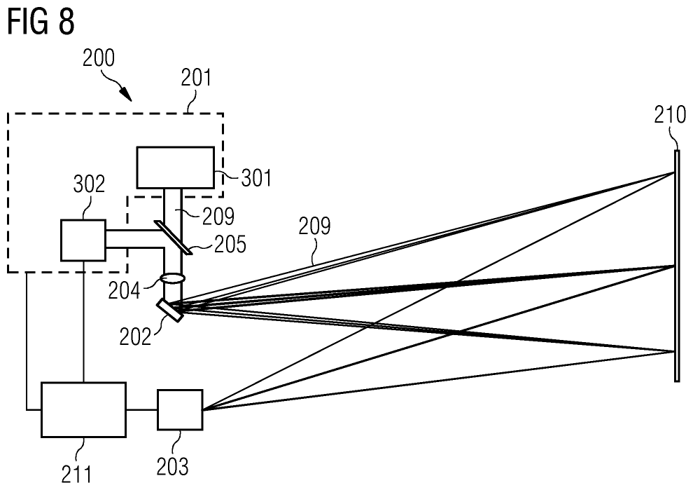

FIG. 8 illustrates a further example in-cabin projection system 200 according to one or more implementations. Compared to the example of FIG. 3, in this implementation the photodetector 203 is arranged such that the light that is reflected back from the projection surface 210 can impinge directly on the photodetector 203 without the 2D scanner 202 on the optical path between said two elements. Such implementations can be advantageous if space at the location of the light transmitter 201 is limited and or a double passing via the 2D scanner 202 is undesired.

### ASPECTS

The following provides an overview of some aspects of the present disclosure:

Aspect 1: An in-cabin projection system (200), comprising: a projection surface (210), a light transmitter (201) configured to generate a plurality of pixel light beams corresponding to an image and transmit the plurality of pixel light beams on an optical path (209) toward the projection surface (210), a two-dimensional (2D) scanner (202) arranged on the optical path, wherein the 2D scanner (202) is configured to receive the plurality of pixel light beams from the light transmitter (201) and steer the plurality of pixel light beams along the optical path (209) according to a 2D scanning pattern, a photodetector (203) configured to detect a portion of light from the light transmitter (201) that is reflected back from the projection surface (210) and to generate a photo signal based on the detected light, and a control unit (211) configured to determine based on the photo signal whether an obstacle is located on the optical path (209).

Aspect 2: The in-cabin projection system (200) according to claim 1, wherein the 2D (202) scanner is further configured to receive the portion of light that is reflected back from the projection surface (210) and direct the portion of light to the photodetector (203).

Aspect 3: The in-cabin projection system (200) according to claim 1 or 2, wherein the 2D scanner (202) is configured to scan the plurality of pixel light beams onto the projection surface (210) according to the 2D scanning pattern.

Aspect 4: The in-cabin projection system (200) according to one of claims 1 to 3, wherein the projection surface (210) is a diffuser screen.

Aspect 5: The in-cabin projection system (200) according to one of claims 1 to 4, wherein the 2D scanner (202) includes a microelectromechanical system (MEMS) mirror (102) configured to oscillate about a first axis (110) according to a first oscillation and oscillate about a second axis (112) according to a second oscillation, and wherein the first oscillation and the second oscillation form the 2D scanning pattern.

Aspect 6: The in-cabin projection system (200) according to one of claims 1 to 5, further comprising a pre-scan lens (204) arranged on the optical path (209) between the light transmitter (201) and the 2D scanner (202), wherein the pre-scan lens (204) is configured to receive the plurality of pixel light beams from the light transmitter (201) and focus the plurality of pixel light beams onto the projection surface (210).

Aspect 7: The in-cabin projection system (200) according to one of claims 1 to 6, wherein the light transmitter (201) is configured to emit a monitoring pixel light beam that is outside the visible range of the electromagnetic spectrum, and wherein the photodetector (203) is configured to generate the photo signal based on the portion of the monitoring pixel light beam that is reflected back from the projection surface (210).

Aspect 8: The in-cabin projection system (200) according to claim 7, wherein the monitoring pixel light beam is characterized by an optical wavelength in the infrared domain, in particular in the NIR domain of the electromagnetic spectrum.

Aspect 9: The in-cabin projection system (200) according to one of claims 1 to 8, wherein the control unit (211), for determining whether an obstacle is located on the optical path (209), is configured to determine from the photo signal a time of flight (TOF) of the portion of light that is reflected back and detected by the photodetector (203) and to compare the determined time of flight to a reference time.

Aspect 10: The in-cabin projection system (200) according to one of claims 1 to 9, wherein the control unit (211), for determining whether an obstacle is located on the optical path (209), is configured to determine from the photo signal a reflectivity map of the portion of light that is reflected back and detected by the photodetector (203) and to compare the determined reflectivity map to a reference reflectivity map.

Aspect 11: The in-cabin projection system (200) according to one of claims 1 to 10, wherein the control unit (211) is further configured to disable the generation of at least some of the plurality of pixel light beams when an obstacle is located on the optical path (209).

Aspect 12: The in-cabin projection system (200) according to claim 11, wherein the control unit (211) is further configured to enable the generation of at least some of the plurality of pixel light beams when no obstacle is located on the optical path (209).

Aspect 13: The in-cabin projection system (200) according to one of claims 1 to 12, wherein the control unit (211) is further configured to determine based on the photo signal whether the obstacle located on the optical path (209) is a finger (602).

Aspect 14: The in-cabin projection system (200) according to claim 13, wherein the control unit (211) is further configured to control the generation of the plurality of pixel light beams to include projected control elements (610) to the image and to monitor whether the finger (602) is located on the optical path (209) of one of the projected control elements (610).

Aspect 15: The in-cabin projection system (200) according to one of claims 1 to 14, wherein the photodetector (203) and the light transmitter (201) are arranged on a same side of the 2D scanner (202).

Aspect 16: The in-cabin projection system (200) according to one of claims 1 to 15, wherein the projection surface (210) is a surface of a vehicle, in particular a surface of a dashboard of a vehicle (700).

Aspect 17: A vehicle (700), comprising an in-cabin projection system (200) according to one of claims 1 to 16, wherein the projection surface (210) is a surface of a dashboard (701) of the vehicle (700).

Aspect 18: A method of projecting an image, the method comprising: generating, by a light transmitter (201), a plurality of pixel light beams corresponding to an image and transmit the plurality of pixel light beams on an optical path (209) toward a projection surface (210); receiving, by a two-dimensional (2D) scanner (202) arranged on the optical path (209), the plurality of pixel light beams and steering the plurality of pixel light beams along the optical path (209) according to a 2D scanning pattern, detecting, by a photodetector (203), a portion of light from the light transmitter (201) that is reflected back from the projection surface (210) and generating a photo signal based on the detected light, and determining, by a control unit (211), based on the photo signal whether an obstacle is located on the optical path (209).

Aspect 19: The method according to claim 18, further comprising: controlling, by the control unit (211), the generation of at least some of the plurality of pixel light beams depending on whether an obstacle is located on the optical path (209).

The foregoing disclosure provides illustration and description but is not intended to be exhaustive or to limit the implementations to the precise form disclosed. Modifications and variations are possible in light of the above disclosure or may be acquired from practice of the implementations.

For example, although implementations described herein relate to MEMS devices with a mirror, it is to be understood that other implementations may include optical devices other than MEMS mirror devices or other MEMS oscillating structures. In addition, although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer, or an electronic circuit.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware can be configured to implement the systems and/or methods based on the description herein.

Further, it is to be understood that the disclosure of multiple acts or functions disclosed in the specification or in the claims may not be construed as to be within the specific order. Therefore, the disclosure of multiple acts or functions will not limit these to a particular order unless such acts or functions are not interchangeable for technical reasons. Furthermore, in some implementations a single act may include or may be broken into multiple sub acts. Such sub acts may be included and part of the disclosure of this single act unless explicitly excluded.

Instructions may be executed by one or more processors, such as one or more central processing units (CPU), digital signal processors (DSPs), general purpose microprocessors, application specific integrated circuits (ASICs), field programmable logic arrays (FPLAs), or other equivalent integrated or discrete logic circuitry. Accordingly, the term “processor” or “processing circuitry” as used herein refers to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

Thus, the techniques described in this disclosure may be implemented, at least in part, in hardware, software executing on hardware, firmware, or any combination thereof. For example, various aspects of the described techniques may be implemented within one or more processors, including one or more microprocessors, DSPs, ASICs, or any other equivalent integrated or discrete logic circuitry, as well as any combinations of such components.

A controller including hardware may also perform one or more of the techniques described in this disclosure. Such hardware, software, and firmware may be implemented within the same device or within separate devices to support the various techniques described in this disclosure. Software may be stored on a non-transitory computer-readable medium such that the non-transitory computer readable medium includes a program code or a program algorithm stored thereon which, when executed, causes the controller, via a computer program, to perform the steps of a method.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. An in-cabin projection system, comprising:
a projection surface;
a light transmitter configured to generate a plurality of pixel light beams corresponding to an image and transmit the plurality of pixel light beams on an optical path toward the projection surface;
a two-dimensional (2D) scanner arranged on the optical path, wherein the 2D scanner is configured to receive the plurality of pixel light beams from the light transmitter and steer the plurality of pixel light beams along the optical path according to a 2D scanning pattern;
a photodetector configured to detect a portion of light from the light transmitter that is reflected back from the projection surface and to-generate a photo signal based on the detected light; and
a controller configured to determine based on the photo signal whether an obstacle is located on the optical path.

2. The in-cabin projection system according to claim 1, wherein the 2D scanner is further configured to receive the portion of light that is reflected back from the projection surface and direct the portion of light to the photodetector.

3. The in-cabin projection system according to claim 1, wherein the 2D scanner is configured to scan the plurality of pixel light beams onto the projection surface according to the 2D scanning pattern.

4. The in-cabin projection system according to claim 1, wherein the projection surface is a diffuser screen.

5. The in-cabin projection system according to claim 1, wherein the 2D scanner includes a microelectromechanical system (MEMS) mirror configured to oscillate about a first axis according to a first oscillation and oscillate about a second axis according to a second oscillation, and
wherein the first oscillation and the second oscillation form the 2D scanning pattern.

6. The in-cabin projection system according to claim 1, further comprising:
a pre-scan lens arranged on the optical path between the light transmitter and the 2D scanner,
wherein the pre-scan lens is configured to receive the plurality of pixel light beams from the light transmitter and focus the plurality of pixel light beams onto the projection surface.

7. The in-cabin projection system according to claim 1, wherein the light transmitter is configured to emit a monitoring pixel light beam that is outside a visible range of an electromagnetic spectrum, and
wherein the photodetector is configured to generate the photo signal based on a portion of the monitoring pixel light beam that is reflected back from the projection surface.

8. The in-cabin projection system according to claim 7, wherein the monitoring pixel light beam is characterized by an optical wavelength in an infrared domain.

9. The in-cabin projection system according to claim 1, wherein the controller is configured to determine from the photo signal a time-of-flight of the portion of light that is reflected back and detected by the photodetector, and compare the time-of-flight to a reference time.

10. The in-cabin projection system according to claim 1, wherein the controller is configured to determine from the photo signal a reflectivity map of the portion of light that is reflected back and detected by the photodetector, and compare the reflectivity map to a reference reflectivity map.

11. The in-cabin projection system according to claim 1, wherein the controller is further configured to disable a generation of at least some of the plurality of pixel light beams based on the obstacle being located on the optical path.

12. The in-cabin projection system according to claim 11, wherein the controller is further configured to enable the generation of at least some of the plurality of pixel light beams based on no obstacle being located on the optical path.

13. The in-cabin projection system according to claim 1, wherein the controller is further configured to determine based on the photo signal whether the obstacle located on the optical path is a finger.

14. The in-cabin projection system according to claim 13, wherein the controller is further configured to control a generation of the plurality of pixel light beams to include projected control elements to the image and to monitor whether the finger is located on the optical path of one of the projected control elements.

15. The in-cabin projection system according to claim 1, wherein the photodetector and the light transmitter are arranged on a same side of the 2D scanner.

16. The in-cabin projection system according to claim 1, wherein the projection surface is a surface of a vehicle.

17. A vehicle, comprising:
an in-cabin projection system, comprising:
a projection surface;
a light transmitter configured to generate a plurality of pixel light beams corresponding to an image and transmit the plurality of pixel light beams on an optical path toward the projection surface;
a two-dimensional (2D) scanner arranged on the optical path, wherein the 2D scanner is configured to receive the plurality of pixel light beams from the light transmitter and steer the plurality of pixel light beams along the optical path according to a 2D scanning pattern;
a photodetector configured to detect a portion of light from the light transmitter that is reflected back from the projection surface and generate a photo signal based on the detected light; and
a controller configured to determine based on the photo signal whether an obstacle is located on the optical path,
wherein the projection surface is a surface of a dashboard of the vehicle.

18. A method of projecting an image, the method comprising:
generating, by a light transmitter, a plurality of pixel light beams corresponding to an image and transmit the plurality of pixel light beams on an optical path toward a projection surface;
receiving, by a two-dimensional (2D) scanner arranged on the optical path, the plurality of pixel light beams and steering the plurality of pixel light beams along the optical path according to a 2D scanning pattern;
detecting, by a photodetector, a portion of light from the light transmitter that is reflected back from the projection surface and generating a photo signal based on the portion of light; and
determining, by a controller, whether an obstacle is located on the optical path based on the photo signal.

19. The method according to claim 18, further comprising:
controlling, by the controller, a generation of at least some of the plurality of pixel light beams depending on whether the obstacle is located on the optical path.
